(19) United States
(12) Patent Application Publication
(10) Pub. No.: US 2022/0089398 A1
(43) Pub. Date: Mar. 24, 2022

(54) PRINTING APPARATUS

(71) Applicant: SCREEN HOLDINGS CO., LTD., Kyoto (JP)

(72) Inventor: Shinji Hayashi, Kyoto (JP)

(21) Appl. No.: 17/459,694

(22) Filed: Aug. 27, 2021

(30) Foreign Application Priority Data
Sep. 18, 2020 (JP) 2020-157329

(51) Int. Cl. B65H 29/12; B41J 29/17; B41J 29/377

(52) U.S. Cl. CPC B65H 29/125; B65H 2515/40; B41J 29/377; B41J 29/17

(57) ABSTRACT

A printing apparatus comprises: a printing unit configured to cause inks to adhere to a base material; a drying unit located downstream of the printing unit in a transportation direction of the base material and configured to dry the inks adhering to the base material with use of heat; an imaging unit located downstream of the drying unit in the transportation direction of the base material and configured to image the base material; a first drive roller located downstream of the drying unit and upstream of the imaging unit in the transportation direction of the base material and configured to apply a transportation force to the base material with a function of cooling the base material; and a second drive roller located downstream of the imaging unit in the transportation direction of the base material and configured to apply a transportation force to the base material.

### CROSS-REFERENCE TO RELATED APPLICATIONS

This application claims priority to Japanese Patent Application No. 2020-157329 filed Sep. 18, 2020, the subject matter of which is incorporated herein by reference in entirety.

### TECHNICAL FIELD

The present invention relates to a printing apparatus configured to print images, such as characters and figures, on an elongated base material.

### BACKGROUND ART

A currently-used printing apparatus includes a printing unit, a drying unit, and an image acquisition unit (imaging unit and illuminating unit). The printing unit includes inkjet heads. The heads eject inks to a transparent base material. The drying unit dries the inks by blowing warm air. The image acquisition unit captures a printed image. Defect inspection is performed based on the captured printed image. See, for example, Japanese Patent Publication No. 2019-142007A.

Moreover, a cooling mechanism is provided between the drying unit and the image acquisition unit (scanner) on a transportation path of a print medium. See, for example, Japanese Patent Publication No. 2020-011396A. The cooling mechanism includes a plurality of cooling driven rollers (cooling rollers). The cooling driven rollers cool the print medium. The cooling driven rollers are each configured such that a refrigerant like water is supplied to one end of a rotary shaft thereof from a refrigerant supply device and is discharged from the other end of the rotary shaft, and then returns back into the refrigerant supply device. See, for example, Japanese Patent Publications No. 2020-011396A and No. 2018-122525A.

### SUMMARY OF INVENTION

### Technical Problem

The following three drawbacks arise when the base material heated by the drying unit is transported to the image acquisition unit (imaging unit and illuminating unit). When the imaging unit is a contact image sensor (CIS), for example, it becomes impossible to capture images if the temperature of the CIS rises to 70° C. or more (first drawback). Increase in temperature of the illuminating unit causes reduced quantity of light, which may lead to degraded inspection quality due to different imaging results among the same pattern (second drawback). The degree of expansion and contraction of the base material due to the temperature is varied depending on types and patterns of the base material, which may cause erroneous detection (third drawback).

Then, a plurality of cooling driven rollers are provided between the drying unit and the imaging unit. This can make both the imaging unit itself and the base material near the imaging unit to be of a constant temperature. Moreover, this can suppress poor imaging and erroneous detection to some extent from a view point of the influence of temperatures.

On the other hand, the cooling driven rollers are sometimes heavy since a refrigerant like water is supplied to the cooling driven rollers individually. Accordingly, inertia and rotational resistance of each of the cooling driven rollers increase. As a result, it becomes difficult to control tension on the base material, leading to possibility that a degree of expansion and contraction of the base material is unstable and inspection is performed inaccurately.

The present invention has been made regarding the state of the art noted above, and its object is to provide a printing apparatus that can perform stable inspection of a base material while tension control is performed easily.

### Solution to Problem

To achieve the object, the present invention provides a configuration as follows. One aspect of the present invention is a printing apparatus for printing an image on a base material, the printing apparatus including a printing unit configured to cause inks to adhere to the base material, a drying unit located downstream of the printing unit in a transportation direction of the base material and configured to dry the inks adhering to the base material with use of heat, an imaging unit located downstream of the drying unit in the transportation direction of the base material and configured to image the base material, a first drive roller located downstream of the drying unit and upstream of the imaging unit in the transportation direction of the base material and configured to apply a transportation force to the base material with a function of cooling the base material, and a second drive roller located downstream of the imaging unit in the transportation direction of the base material and configured to apply a transportation force to the base material.

With the printing apparatus of the present invention, the first drive roller is located upstream of the imaging unit. The first drive roller can cool the base material. This prevents increase in temperature of the base material to a given value or more, which increase may cause poor imaging by the imaging unit. As a result, stable inspection can be maintained. Moreover, a cooling driven roller is a driven roller having a cooling function and configured to apply no transportation force to the base material. With such a cooling driven roller, tension control on the base material may be difficult, and a degree of expansion and contraction of the base material may be unstable, leading to inaccurate inspection. In the aspect of the present invention, the first drive roller having a cooling function is provided. With such a configuration, the roller itself has the cooling function, and a transportation force is applicable to the base material while a rotation speed of the roller is controlled. This enables stable and accurate inspection of the base material under appropriate tension control of the base material.

Moreover, since the first drive roller is located upstream of the imaging unit and the second drive roller is located downstream of the imaging unit, tension on the base material that passes the imaging unit is easily controlled. That is, tension on the base material that passes the imaging unit is not affected by a load from a group of rollers containing the first drive roller and located upstream of the first drive roller. Accordingly, since control of the tension on the base material that passes the imaging unit (tension control by the second drive roller) is easily performed, degradation of the inspection accuracy due to expansion and contraction of the base material can be suppressed.

Moreover, the first drive roller of the printing apparatus described above cools the base material by supplying a refrigerant thereinto. The first drive roller can cool the base material with use of the refrigerant supplied thereinto.

Moreover, the first drive roller of the printing apparatus described above includes a gas-blowing unit, and cools the base material by blowing gas from the gas-blowing unit to a winding region of the base material wound on the first drive roller. The first drive roller can cool the base material with use of gas blown from the gas-blowing unit to the winding region of the base material.

Moreover, it is preferred that the printing apparatus described above further includes a cleaner that is located downstream of the first drive roller and upstream of the imaging unit in the transportation direction of the base material and is configured to remove dust attached to the base material. Accordingly, the imaging unit can capture images in such a condition where the cleaner removes dust. This can prevent erroneous determination of a printed region as defect due to the dust.

Moreover, it is preferred in the printing apparatus described above that the second drive roller is located above the first drive roller, the imaging unit is positioned higher in level than the first drive roller, and the second drive roller is positioned higher in level than the imaging unit. This causes upward transportation of the base material from the bottom in a transportation path between the first drive roller and the second drive roller. As a result, the footprint of the printing apparatus is suppressible.

Moreover, it is preferred in the printing apparatus described above that the imaging unit is formed by a contact image sensor. This prevents increase in temperature of the base material to a given value or more, which increase may cause poor imaging of the contact image sensor. As a result, stable inspection can be maintained.

### Advantageous Effects of Invention

The printing apparatus according to the present invention can achieve easy tension control of the base material as well as stable and accurate inspection of the base material.

### BRIEF DESCRIPTION OF DRAWINGS

For the purpose of illustrating the invention, there are shown in the drawings several forms which are presently preferred, it being understood, however, that the invention is not limited to the precise arrangement and instrumentalities shown.

FIG. 1 schematically illustrates a printing apparatus according to one embodiment of the present invention.

FIG. 2 illustrates an inspecting block and a winding mechanism according to the embodiment.

FIG. 3A illustrates a cooling drive roller, and FIG. 3B is a view from an arrow A-Ain FIG. 3A.

FIG. 4 illustrates two cleaners.

FIG. 5 illustrates two transport rollers and an inspecting unit.

FIG. 6 illustrates a cooling drive roller according to one modification.

### DESCRIPTION OF EMBODIMENT

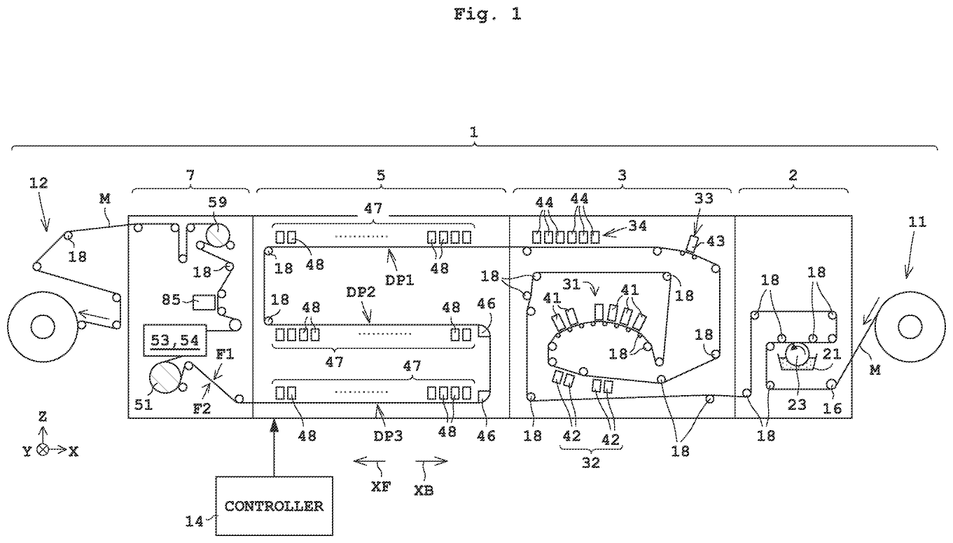

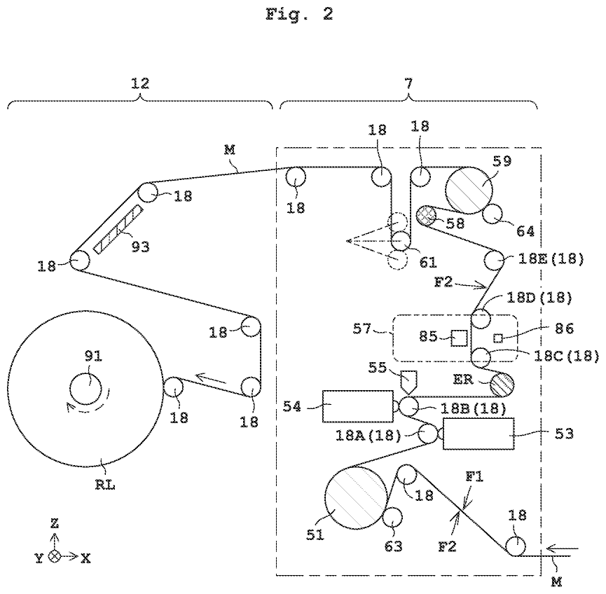

The following describes one embodiment of the present invention with reference to drawings. FIG. 1 schematically illustrates a printing apparatus 1 according to the embodiment of the present invention. FIG. 2 illustrates an inspecting block 7 and a winding mechanism 12 according to the embodiment.

1. Configuration of Printing Apparatus 1

Reference is made to FIG. 1. The printing apparatus 1 includes a coating unit 2, a printing block 3, a drying block 5, an inspecting block 7, a feeding mechanism 11, and a winding mechanism 12. The feeding mechanism 11, the coating unit 2, the printing block 3, the drying block 5, the inspecting block 7, and the winding mechanism 12 are lined up in this order horizontally.

Here, the term “upstream” means an upstream side of a transportation path (or transportation direction) for transporting an elongated transparent base material M. Moreover, the term “downstream” means a downstream side of the transportation path (or transportation direction).

The printing apparatus 1 transports an elongated (or elongated strip) transparent base material (or transparent print medium) M from the feeding mechanism 11 to the winding mechanism 12 in a roll-to-roll manner. The raw material of the transparent base material M is a resin film such as oriented polypropylene (OPP) or polyethylene terephthalate (PET). In the present embodiment, one of both faces of the transparent base material M on which images are printed is called a printing face F1, and the other opposite to the printing face F1 is called a rear face F2.

The coating unit 2 applies a coating liquid to the transparent base material M to be transported. Thereafter, the printing block 3 ejects inks with an inkjet printing system to the transparent base material M to be transported for forming images on the transparent base material M. The drying block 5 dries the inks adhering to the transparent base material M to be transported. The inspecting block 7 performs defect inspection to the images printed on the transparent base material M to be transported.

The printing apparatus 1 includes a controller 14 and a memory unit (e.g., memory) not shown. The controller 14 includes a central processing unit (CPU). The controller 14 controls components of the printing apparatus 1 (e.g., inspecting block 7 and winding mechanism 12). The memory unit stores computer programs necessary for operation of the printing apparatus 1.

1-1. Construction of Coating Unit 2

The coating unit 2 includes a drive roller 16, a plurality of transport rollers 18, a pan 21, and a gravure roller 23. The drive roller 16 is located adjacent to an inlet of the coating unit 2. The drive roller 16 takes the transparent base material M from the feeding mechanism 11. The drive roller 16 and the transport rollers 18 are each supported in a rotatable manner around a horizontal axis in a Y-direction. The drive roller 16 is driven by an electric motor. The transport rollers 18 are each not coupled with a rotary shaft of the electric motor, and applies no transportation force to the transparent base material M. The transport rollers 18 each guide the transparent base material M. The pan 21 stores a liquid primer (_{coa}ting liquid).

A lower portion of the gravure roller 23 is partially immersed in the primer stored in the pan 21. An upper portion of the gravure roller 23 contacts the transparent base material M to be transported. The gravure roller 23 is driven by an electric motor. The gravure roller 23 rotates in a direction opposite to the transportation direction of the transparent base material M. When the gravure roller 23 rotates, the primer is held on an outer circumferential face of the gravure roller 23, and the held primer is transferred to the transparent base material M. Accordingly, the primer is applied to the printing face F1 of the transparent base material M. The transparent base material M on which the primer is applied is transported to the printing block 3.

1-2. Construction of Printing Block 3

The printing block 3 includes a plurality of transport rollers 18, a color printing unit 31, a first drying unit 32, a white color printing unit 33, and a second drying unit 34. The color printing unit 31, the first drying unit 32, the white color printing unit 33, and the second drying unit 34 are arranged in this order along the transportation path of the transparent base material M.

The color printing unit 31 includes a plurality of (e.g., six) ejection heads 41. The six ejection heads 41 are arranged along the transportation path of the transparent base material M. Moreover, the six ejection heads 41 and an ejection head 43 mentioned later are each arranged across the transparent base material M in a width direction (Y-direction) of the transparent base material M. The six ejection heads 41 eject colored inks other than white with an inkjet printing system. The six ejection heads 41 eject inks of cyan, magenta, yellow, black, blue, orange, for example, individually. Accordingly, color figures are formed on the printing face F1 of the transparent base material M.

The first drying unit 32 includes a plurality of nozzles 42 arranged along the transportation path. The nozzles 42 and a plurality of nozzles 44 and 48 mentioned later include ejection ports individually elongated in the Y-direction. The ejection ports of the nozzles 42 and the nozzles 44 and 48 mentioned later are each arranged across the transparent base material M in the width direction (Y-direction) of the transparent base material M. The nozzles 42 each eject air at room temperatures, for example, that are generated by an electric fan. Accordingly, drying operation is performed for the inks of the six colors adhering to the printing face F1 of the transparent base material M.

The white color printing unit 33 includes one ejection head 43. The ejection head 43 ejects a white ink with an inkjet printing system. Accordingly, a while color figure is formed on the printing face F1 of the transparent base material M.

The second drying unit 34 includes a plurality of nozzles 44 arranged along the transportation direction. The nozzles 44 each eject air at room temperatures, for example, that are generated by an electric fan. Accordingly, drying operation is performed for the white ink adhering to the printing face F1 of the transparent base material M. The transparent base material M having passed the second drying unit 34 is transported to the drying block 5. 1-3. Construction of Drying Block 5

The drying block 5 includes a plurality of (e.g., three) stages of drying paths DP1 to DP3, a plurality of transport rollers 18, two air turn bars 46, and a drying unit 47. The two air turn bars 46 each eject air from an ejection port, not shown. The two air turn bars 46 can fold the transparent base material M in a non-contact manner. The three stages of the drying paths DP1 to DP3 are arranged in an up-down direction, and are formed by an upper-stage drying path DP1, a middle-stage drying path DP2, and a lower-stage drying path DP3. That is, the transparent base material M is transported in the drying block 5 in an S-shaped manner.

Detailed description is as under. The transparent base material M is transported along the upper-stage drying path DP1 in a forward direction XF from the printing block 3 to the inspecting block 7, and is folded with the two transport rollers 18. Then, the transparent base material M is transported along the middle-stage drying path DP2 in a reverse direction XB from the inspecting block 7 to the printing block 3, and is folded with the two air turn bars 46 in a non-contact manner. Then, the transparent base material M is transported along the lower-stage drying path DP3 in the forward direction XF. The three stages of the drying paths DP1 to DP3 are each provided with a drying unit 47. The drying unit 47 includes a plurality of nozzles 48. The nozzles 48 each eject air (warm air) that is generated by an electric fan, for example, and is heated with a heater to 80° C., for example. The nozzles 48 eject warm air to the printing face F1 of the transparent base material M. This further dries the transparent base material M. The transparent base material M having passed the three drying paths DP1 to DP3 is transported to the inspecting block 7.

1-4. Construction of Inspecting Block 7

The following describes the inspecting block 7 as the characteristic of the present invention. Reference is made to FIG. 2.

The inspecting block 7 includes a plurality of transport rollers 18, a cooling drive roller 51, a first cleaner 53, a second cleaner 54, a sensor 55, an encoder roller ER, an inspecting unit 57, a tension detecting roller 58, a downstream detection drive roller 59, a dancer roller 61, and nip rollers 63 and 64. Here, the nip roller 63 is located so as to sandwich the transparent base material M with the cooling drive roller 51. Moreover, the rollers such as the transport rollers 18, the cooling drive roller 51, and the downstream detection drive roller 59 are supported rotatably around the horizontal axis in the Y-direction.

The cooling drive roller 51 corresponds to the first drive roller in the present invention. The downstream detection drive roller 59 corresponds to the second drive roller in the present invention.

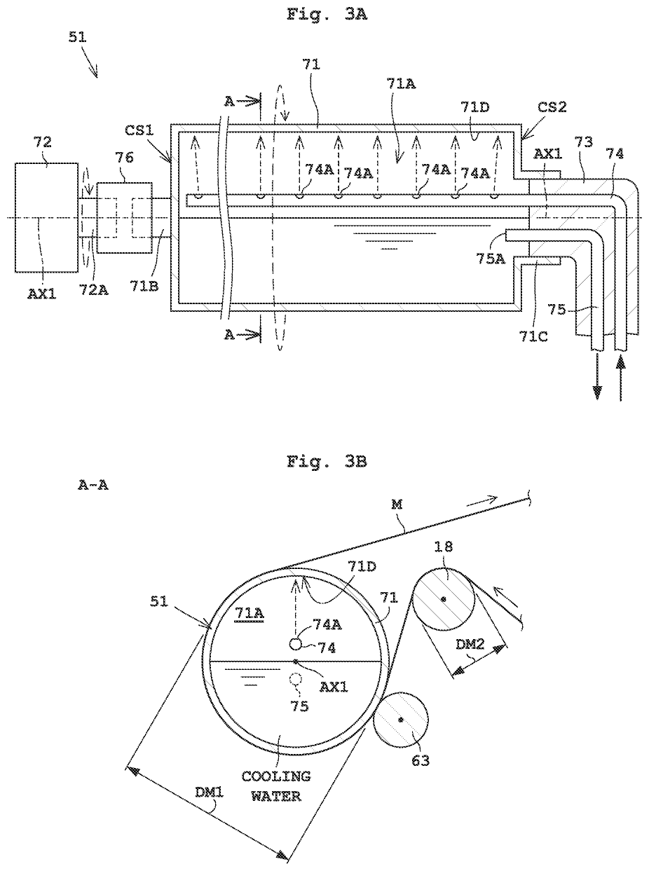

FIG. 3A illustrates the cooling drive roller 51. FIG. 3B is a sectional view from an A-A arrow direction of FIG. 3A. The cooling drive roller 51 is provided downstream of the drying unit 47 (drying block 5), and is configured to transmit a transportation force to the transparent base material M and to cool the transparent base material M. The cooling drive roller 51 includes a roller body 71, an electric motor 72, a rotary joint 73, a liquid supplying pipe 74, a liquid discharging pipe 75, and a coupling 76. Here, as shown in FIG. 3B, the cylindrical cooling drive roller has an outer circumferential diameter DM1 larger than an outer circumferential diameter DM2 of the transport roller 18.

The roller body 71 includes a reservoir 71A, a rotary shaft 71B, and a hollow shaft 71C. The reservoir 71A is formed in an interior space of the cylindrical roller body 71. The rotary shaft 71B is provided on a circular side face CS1 at a first end of the roller body 71.

The hollow shaft 71C is provided on a circular side face CS2 at a second end of the roller body 71. The hollow shaft 71C is formed in a tubular shape. Accordingly, the interior of the hollow shaft 71C serves as a passage for the reservoir 71A. One end of the rotary joint 73 is inserted into the hollow shaft 71C. Accordingly, the rotary joint 73 closes the inside of the hollow shaft 71C and the reservoir 71A, and is coupled with the hollow shaft 71C rotatably around a horizontal axis AX1.

The coupling 76 couples a rotary shaft 72A of the electric motor 72 with a rotary shaft 71B of the roller body 71. Accordingly, rotation of the rotary shaft 72A of the electric motor 72 causes rotation of the roller body 71. Moreover, the hollow shaft 71C rotates integrally with the roller body 71. In contrast to this, the rotary joint 73, the liquid supplying pipe 74, and the liquid discharging pipe 75 are fixed without rotating integrally with the roller body 71 and the hollow shaft 71C.

The liquid supplying pipe 74 and the liquid discharging pipe 75 are arranged so as to pass through the rotary joint 73. One ends of the liquid supplying pipe 74 and the liquid discharging pipe 75, respectively, are arranged so as to pass through the hollow shaft 71C into the reservoir 71A. The liquid supplying pipe 74 extends close to the rotary shaft 71B along the horizontal axis AX1. The liquid supplying pipe 74 arranged in the reservoir 71A has a plurality of ejection ports 74A formed therein. The ejection ports 74A are lined up along the horizontal axis AX1. Moreover, the ejection ports 74A are each opened upward. An outlet 75Ais formed at the end of the liquid discharging pipe 75.

A cooling water circulation mechanism, not shown, (provided with a pump, for example) supplies cooling water (also called constant-temperature water) to the liquid supplying pipe 74. The cooling water has temperatures controlled to 20° C. to 25° C. The cooling water is ejected from the ejection ports 74A upward. Moreover, the ejected cooling water reaches an upper inner wall 71D. In FIG. 3A, the cooling water is stored in the reservoir 71A to about half the capacity of the reservoir 71A, for example. In this regard, the cooling water may be stored in the reservoir 71A to substantially all the capacity of the reservoir 71A. Moreover, an amount of cooling water in the reservoir 71A may be set appropriately. The cooling water within the reservoir 71A is collected via the outlet 75A into the liquid discharging pipe 75. The collected cooling water is again supplied to the liquid supplying pipe 74 with the cooling water circulation mechanism.

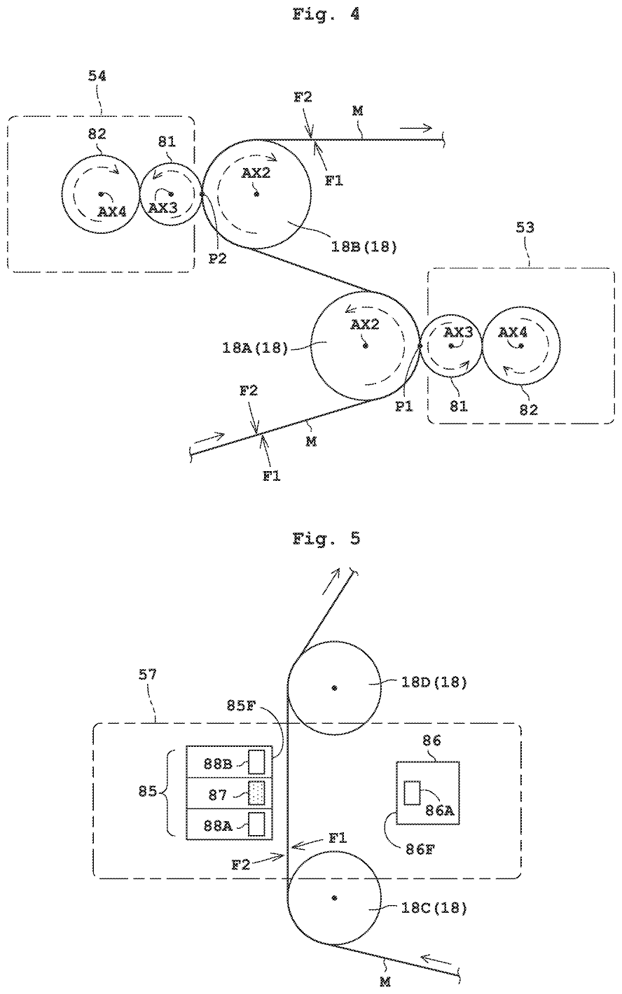

Reference is made again to FIG. 2. Two cleaners 53 and 54 are provided downstream of the cooling drive roller 51. The first cleaner 53 removes dust attached to the printing face F1 of the transparent base material M. The second cleaner 54 removes dust attached to the rear face F2 of the transparent base material M opposite to the printing face F1. The second cleaner 54 removes dust at a position on the transportation path of the transparent base material M, which position differs from that of the first cleaner 53. That is, as shown in FIG. 4, it is assumed that a position where the first cleaner 53 removes dust is a position P1 and a position where the second cleaner 54 removes dust is a position P2. In this case, the position P1 differs from the position P2.

FIG. 4 illustrates the two cleaners 53 and 54. The two transport rollers 18A and 18B each transport the transparent base material M in an S-shaped manner. The transparent base material M is wound on the transport roller 18A such that the transport roller 18A contacts the rear face F2. Moreover, the transparent base material M is wound on the transport roller 18B such that the transport roller 18B contacts the printing face F1.

The first cleaner 53 removes dust attached to the printing face F1 at a region of the transparent base material M, the region being wound on the transport roller 18A. The second cleaner 54 removes dust attached to the rear face F2 at a region of the transparent base material M, the region being wound on the transport roller 18B.

The first cleaner 53 includes a removal roller 81 and an adhesion roller 82. The removal roller 81 and the adhesion roller 82 are each arranged across the transparent base material M in the width direction of the transparent base material M. The removal roller 81 is made of a flexible material such as rubber. The transport rollers 18A and 18B are made of metal. That is, the removal roller 81 is made of a material softer than the transport rollers 18A and 18B. The transport roller 18A rotates around a horizontal axis AX2. The removal roller 81 rotates around a horizontal axis AX3. The adhesion roller 82 rotates around a horizontal axis AX4.

The removal roller 81 is brought into line contact with the transparent base material M. The adhesion roller 82 is brought into line contact with the removal roller 81. Transportation of the transparent base material M causes the transport roller 18A and the removal roller 81 to rotate and causes the adhesion roller 82 contacting the removal roller 81 to rotate. Rotation of the removal roller 81 causes removal of the dust attached to the printing face F1 of the transparent base material M. That is, an adhesion force of the removal roller 81 causes the dust to be attached to the removal roller 81. Then, the dust attached to the removal roller 81 is transferred to the adhesion roller 82. In such a manner as above, the first cleaner 53 removes dust attached to the printing face F1.

Note that, as shown in FIG. 4, the second cleaner 54 is configured in the same manner as the first cleaner 53. The second cleaner 54 removes dust attached to the rear face F2. Here, the adhesion roller 82 is formed by an adhesive sheet in a roll form like an adhesive tape. The adhesive sheet to which the dust is transferred is separated and cut off, whereby a new adhesive face is exposed.

Reference is made again to FIG. 2. The sensor 55 is provided downstream of the second cleaner 54. Moreover, the encoder roller ER is provided downstream of the sensor 55. The sensor 55 is formed by a contrast sensor, an image sensor like a charge-coupled device (CCD) or a complementary metal oxide semiconductor (CMOS), a contact image sensor (CIS), a photoelectric sensor, or a laser sensor. The sensor 55 detects a head mark on each page printed by the color printing unit 31 from a side adjacent to the rear face F2. For example, when the sensor 55 is a contrast sensor, the contrast sensor detects presence and absence of the head mark with use of a quantity of reflected light. Moreover, the sensor 55 detects a head mark at the region wound on the transport roller 18B. The encoder roller ER detects a moving distance of the transparent base material M. The encoder roller ER includes a rotary encoder, for example. The controller 14 (see FIG. 1) can calculate a distance between the detected head mark and an imaging unit 85 from the head mark detected by the sensor 55 and the moving distance detected by the encoder roller ER, for example.

The two transport rollers 18C and 18D, and the inspecting unit 57 are provided downstream of the encoder roller ER. The transport roller 18C is positioned higher in level than the two cleaners 53 and 54, and guides the transparent base material M vertically upward. The inspecting unit 57 captures an image of the transparent base material M from the rear face F2 to perform defect inspection to the printed region. The reason why the image is captured from the rear face F2 is that the image cannot be recognized accurately since the figure with the white color ink is finally printed. Moreover, a consumer sees the rear face F2. As illustrated in FIG. 5, the inspecting unit 57 includes the imaging unit 85 and an illuminating unit 86. The imaging unit 85 and the illuminating unit 86 face each other across the transparent base material M, transported by the transport roller 18C vertically upward, in the horizontal direction.

That is, the imaging unit 85 faces the illuminating unit 86 horizontally, and the illuminating unit 86 faces the imaging unit 85 horizontally. Moreover, the imaging unit 85 has a front face 85F arranged along the vertical direction, and the illuminating unit 86 has a front face 86F arranged along the vertical direction.

The imaging unit 85 is formed by a contact image sensor (CIS), for example, as one type of a line sensor. When the imaging unit 85 is formed by the CIS, the imaging unit 85 includes an image sensor 87, two light sources 88A and 88B, and an equal magnification imaging lens not shown, for example. The two light sources 88A and 88B are located along the transportation direction. The image sensor 87 is located between the two light sources 88A and 88B. Each of the two light sources 88A and 88B is a light emitting diode (LED), for example. The image sensor 87 is formed by a CMOS image sensor, for example. Light emitted from each of the two light sources 88A and 88B is reflected on the transparent base material M to enter the image sensor 87.

The illuminating unit 86 includes a light source 86A such as a light-emitting diode (LED). The light source 86A emits white light. The light emitted from the illuminating unit 86 penetrates the transparent base material M to enter the image sensor 87. Here, the illuminating unit 86 may cause the light emitted from the light source 86A and reflected on a reflective plate to enter the image sensor 87. A diffusion plate is provided on the front face 85F of the illuminating unit 86 as necessary.

The tension detecting roller 58 is provided downstream of the two transport rollers 18C and 18D and the inspecting unit 57. Moreover, the downstream detection drive roller 59 is provided downstream of the tension detecting roller 58. The tension detecting roller 58 includes a strain gauge, for example, to detect tension on the transparent base material M. The tension detected by the tension detecting roller 58 is used for tension control of the transportation path between the cooling drive roller 51 and the downstream detection drive roller 59. The downstream detection drive roller 59 is driven by an electric motor. The downstream detection drive roller 59 is a drive roller located next to the cooling drive roller 51. The nip roller 64 is located so as to sandwich the transparent base material M with the downstream detection drive roller 59. The dancer roller 61 is provided downstream of the downstream detection drive roller 59.

Here, the controller 14 (see FIG. 1) operates the downstream detection drive roller 59 in accordance with the tension detected by the tension detecting roller 58, thereby controlling the tension on the transparent base material M between the cooling drive roller 51 and the downstream detection drive roller 59 so as to be of a pre-set value, for example. In other words, the controller 14 controls the tension between the two drive rollers 51 and 59 to be constant.

Reference is made to FIG. 2. The transparent base material M is transported so as to move upward from the bottom on the transportation path between the cooling drive roller 51 and the downstream detection drive roller 59 in the inspecting block 7. Detailed description is as under. The inspecting block 7 includes two drive rollers (i.e., cooling drive roller 51 and downstream detection drive roller 59). The downstream detection drive roller 59 is located above the cooling drive roller 51. Moreover, the two cleaners 53 and 54 are positioned higher in level than the cooling drive roller 51. The transport roller 18C is positioned higher in level than the two cleaners 53 and 54. The inspecting unit 57 (imaging unit 85 and illuminating unit 86) is positioned higher in level than the transport roller 18C. The downstream detection drive roller 59 is positioned higher in level than the inspecting unit 57. Such a configuration as above can suppress footprint of the inspecting block 7, i.e., the printing apparatus 1. The transparent base material M is transported to the winding mechanism 12.

1-5. Construction of Winding Mechanism 12

The winding mechanism 12 includes a plurality of transport rollers 18, a winding roller 91, and a splicer 93. The winding roller 91 is driven by an electric motor. The winding roller 91 is provided downstream of the downstream detection drive roller 59. Moreover, the winding roller 91 is positioned lower in level than the downstream detection drive roller 59. That is, the winding mechanism 12 causes the transparent base material M, transported so as to move upward from the bottom in the inspecting block 7, to move downward.

The splicer 93 is located along a transportation path from the downstream detection drive roller 59 to the winding roller 91. Moreover, the splicer 93 is located above the winding roller 91. Specifically, the splicer 93 is located vertically above a half side, adjacent to the inspecting block 7, of a roll RL of the transparent base material M wound onto the winding roller 91. Moreover, the splicer 93 is positioned lower in level than the downstream detection drive roller 59.

The splicer 93 is used for cut-off and connection of the transparent base material M. The splicer 93 corresponds to a workbench in the present invention. The transparent base material M is transported so as to move upward from the bottom on the transportation path between the cooling drive roller 51 and the downstream detection drive roller 59. Accordingly, the transparent base material M need to be moved downward to the winding roller 91. At this time, the transparent base material M passes via the splicer 93 positioned above the winding roller 91 and lower in level then the downstream detection drive roller 59. This can suppress footprint of the printing apparatus 1 while the transparent base material M is transported so as to be moved downward from the downstream detection drive roller 59 to the winding roller 91.

2. Operation of Printing Apparatus

The following simply describes operation of the printing apparatus 1, especially operation of the inspecting block 7 and the winding mechanism 12. The drying unit 47 of the drying block 5 shown in FIG. 1 feeds warm air to the transparent base material M from the nozzles 48 to dry the inks adhering to the transparent base material M. Accordingly, the transparent base material M where the ink is dried by the drying unit 47 is heated. The heated transparent base material M is transported to the inspecting block 7.

Reference is made to FIG. 2. The heated transparent base material M is transported to the cooling drive roller 51. The cooling drive roller 51 cools the transparent base material M. This prevents increase in temperature of the transparent base material M to a given value or more, which may cause poor imaging by the imaging unit 85. As a result, stable inspection can be maintained. Thereafter, the transparent base material M is transported to the two cleaners 53 and 54. The two cleaners 53 and 54 remove dust attached to both faces (printing face F1 and rear face F2) of the transparent base material M.

Thereafter, the transparent base material M is transported to the sensor 55 and the encoder roller ER in this order. The sensor 55 detects the head mark on each page. The encoder roller ER calculates a transportation distance of the transparent base material M. After transported to the encoder roller ER, the transparent base material M is transported to the two transport rollers 18C and 18D and the inspecting unit 57 (imaging unit 85 and illuminating unit 86). The transport roller 18C guides the transparent base material M vertically upward. The imaging unit 85 and the illuminating unit 86 face each other across the transparent base material M, transported by the transport roller 18C vertically upward, in the horizontal direction. Accordingly, dust is unlikely to be attached to the front face 85F of the imaging unit 85 and the front face 86F of the illuminating unit 86. This can prevent poor imaging due to the dust.

The imaging unit 85 captures a printed image from the rear face F2. Defect inspection is performed based on data about the captured printed image. The dust attached to the transparent base material M is removed near the imaging unit 85, the encoder roller ER, and the sensor 55. This can prevent erroneous determination for defect caused by the dust.

After transported to the inspecting unit 57, the transparent base material M is transported to the downstream detection drive roller 59 and the dancer roller 61 in this order. Thereafter, the transparent base material M is transported to the splicer 93. The splicer 93 is a workbench. An operator can cut-off or connect the transparent base material M with the splicer 93. The winding roller 91 winds the transparent base material M having passed the splicer 93.

With the present embodiment, the cooling drive roller 51 is provided upstream of the imaging unit 85. The cooling drive roller 51 can cool the transparent base material M. This prevents increase in temperature of the transparent base material M to a given value or more, which may cause poor imaging by the imaging unit 85. As a result, stable inspection can be maintained. Moreover, a cooling driven roller is a driven roller having a cooling function and configured to apply no transportation force to the transparent base material M. Such a cooling driven roller makes it difficult to control tension on the transparent base material M, leading to possibility that a degree of expansion and contraction of the transparent base material M is unstable and inspection is performed inaccurately. The cooling drive roller 51 according to the present embodiment has the cooling function to cool the transparent base material M and a transportation force is applicable to the transparent base material M while a rotation speed of the roller is controlled. This enables stable and accurate inspection of the base material under appropriate tension control of the base material.

Moreover, since the cooling drive roller 51 is located upstream of the imaging unit 85 and the downstream detection drive roller 59 is located downstream of the imaging unit 85, tension on the transparent base material M that passes the imaging unit 85 is easily controlled. That is, tension on the transparent base material M that passes the imaging unit 85 is not affected by a load from a group of transport rollers 18 containing the cooling drive roller 51 and located upstream of the cooling drive roller 51. Accordingly, since control of the tension on the transparent base material M that passes the imaging unit 85 (tension control by the downstream detection drive roller 59) is easily performed, degradation of the inspection accuracy due to expansion and contraction of the transparent base material M can be suppressed.

Moreover, the inspecting block 7 includes the two cleaners 53 and 54 that are located downstream of the cooling drive roller 51 and upstream of the inspecting unit 57 in the transportation direction of the transparent base material M and are configured to remove dust attached to the transparent base material M. Accordingly, the inspecting unit 57 can perform inspection in such a conclisition where the two cleaners 53 and 54 remove dust. As a result, the inspecting unit 57 can prevent erroneous determination of a printed region part as defect due to the dust.

Moreover, the downstream detection drive roller 59 is located above of the cooling drive roller 51 in the inspecting block 7. The imaging unit 85 is positioned higher in level than the cooling drive roller 51. The downstream detection drive roller 59 is positioned higher in level than the imaging unit 85. Accordingly, the transparent base material M is transported so as to move upward from the bottom on the transportation path between the cooling drive roller 51 and the downstream detection drive roller 59. As a result, the footprints of the inspecting block 7 and the printing apparatus 1 are suppressible.

The present invention is not limited to the foregoing examples, but may be modified as follows.

(1) The embodiment described above is configured such that the cooling water is supplied in the cooling drive roller 51. In this regard, a refrigerant supplied in the cooling drive roller 51 is not limited to water, but may be oil. Moreover, a refrigerant is not limited to a liquid but may be gas.

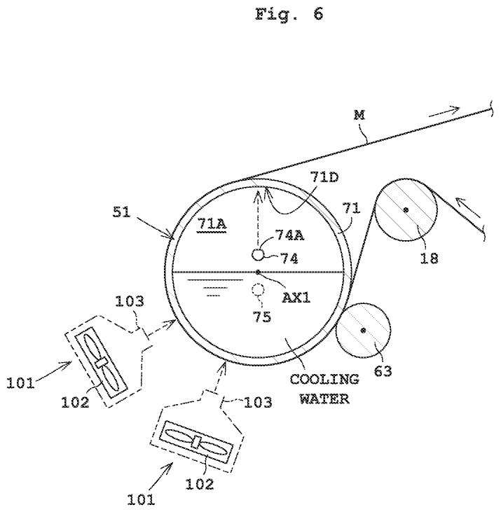

(2) In the embodiment and the modification (1) described above, the inspecting block 7 includes the cooling drive roller 51. The cooling drive roller 51 may include a gas-blowing unit 101 for enhancing cooling capacity. In FIG. 6, two gas-blowing units 101 are provided. In this regard, one gas-blowing unit 101 or three or more gas-blowing units 101 may be provided.

The two gas-blowing units 101 are arranged along the transportation direction of the transparent base material M. The gas-blowing units 101 each include a fan 102 and a nozzle 103. The fan 102 is driven by an electric motor, for example. The nozzle 103 has an ejection port elongated in the Y-direction. The ejection port is arranged across the transparent base material M in the width direction (Y-direction) of the transparent base material M. The gas-blowing units 101 each cool the transparent base material M by blowing gas to a winding region of the transparent base material M wound onto the cooling drive roller 51 (roller body 71).

Note that, when the cooling drive roller 51 includes the gas-blowing units 101 shown in FIG. 6, the cooling drive roller 51 may be configured such that the refrigerant is not supplied therein.

(3) In the embodiment and the modifications described above, the imaging unit 85 is formed by the CIS. In this regard, the imaging unit 85 may be a line sensor camera. The line sensor camera includes a CCD image sensor, for example. Moreover, the line sensor camera may include two light sources emitting light from upstream and downstream of the CCD image sensor.

(4) In the embodiment and the modifications described above, the second cleaner 54 removes dust at a position different from that of the first cleaner 53, as shown in FIG. 4. In this regard, the second cleaner 54 may remove dust at a position same as that of the first cleaner 53. In this case, a predetermined position of the transparent base material M is sandwiched with the two removal rollers 81 of the two cleaners 53 and 54.

(5) In the embodiment and the modifications described above, the two cleaners 53 and 54 are each a contact cleaner. In this regard, at least either the cleaner 53 or 54 may be a non-contact cleaner. For example, the first cleaner 53 may generate ultrasonic waves to remove dust attached to the transparent base material M. Moreover, the first cleaner 53 may blow out gas from the nozzle to remove dust attached to the transparent base material M.

(6) In the embodiment and the modifications described above, the color printing unit 31 ejects the inks of six colors, but the inks of six colors are not limitative. For example, the color printing unit 31 may eject inks of four colors, i.e., cyan, magenta, yellow, and black. That is, the color printing unit 31 may merely eject inks of a plurality of colors. The colors of the inks are set appropriately other than a while color.

(7) In the embodiment and the modifications described above, the first cleaner 53 removes dust attached to the printing face F1 (first face), and the second cleaner 54 removes dust attached to the rear face F2 (second face). In this regard, such roles are reversible. That is, the first cleaner 53 may remove dust attached to the rear face F2 (first face), and the second cleaner 54 may remove dust attached to the printing face F1 (second face).

(8) In the embodiment and the modifications described above, at least one of the transport rollers 18 may be replaced by the drive roller 16 driven by the electric motor on the transportation path other than the transportation path between the two drive rollers 51 and 59.

(9) In the embodiment and the modifications described above, the printing apparatus 1 prints the image on the transparent base material M. In this regard, the printing apparatus 1 may print the figures on a non-transparent base material. In this case, the illuminating unit 86 of the inspecting unit 57 need not be provided. Moreover, the printing apparatus 1 may print the figures on web paper. In this case, the printing apparatus 1 need not include the coating unit 2.

(10) In the embodiment and the modifications described above, the printing block 3 ejects inks with an inkjet printing system to the transparent base material M to be transported for forming figures on the transparent base material M. However, such an inkjet printing system is not limitative. For example, the printing block 3 may cause the inks to adhere to the transparent base material M by offset printing or gravure printing.

The present invention may be embodied in other specific forms without departing from the spirit or essential attributes thereof and, accordingly, reference should be made to the appended claims, rather than to the foregoing specification, as indicating the scope of the invention.

What is claimed is:

1. A printing apparatus for printing an image on a base material, the printing apparatus comprising:
a printing unit configured to cause inks to adhere to the base material;
a drying unit located downstream of the printing unit in a transportation direction of the base material and configured to dry the inks adhering to the base material with use of heat;
an imaging unit located downstream of the drying unit in the transportation direction of the base material and configured to image the base material;
a first drive roller located downstream of the drying unit and upstream of the imaging unit in the transportation direction of the base material and configured to apply a transportation force to the base material with a function of cooling the base material; and
a second drive roller located downstream of the imaging unit in the transportation direction of the base material and configured to apply a transportation force to the base material.

2. The printing apparatus according to claim 1, wherein the first drive roller cools the base material by supplying a refrigerant thereinto.

3. The printing apparatus according to claim 1, wherein
the first drive roller includes a gas-blowing unit, and cools the base material by blowing gas from the gas-blowing unit to a winding region of the base material wound on the first drive roller.

4. The printing apparatus according to claim 1, further comprising:
a cleaner located downstream of the first drive roller and upstream of the imaging unit in the transportation direction of the base material, and configured to remove dust attached to the base material.

5. The printing apparatus according to claim 1, wherein
the second drive roller is located above the first drive roller,
the imaging unit is positioned higher in level than the first drive roller, and
the second drive roller is positioned higher in level than the imaging unit.

6. The printing apparatus according to claim 1, wherein
the imaging unit is formed by a contact image sensor.
